(19) United States
(12) Patent Application Publication
(10) Pub. No.: US 2010/0132570 A1
(43) Pub. Date: Jun. 3, 2010

(54) PRINTING METHOD BY OFFSET PRINTING PRESS AND OFFSET PRINTING PRESS

(75) Inventors: Yasuharu Suda, Hyogo (JP); Fumiko Omae, Hiroshima (JP); Mitsuru Tabuchi, Hiroshima (JP); Koji Nishiyama, Hiroshima (JP); Masakazu Akatsuka, Hiroshima (JP); Fumio Wakisaka, Hiroshima (JP)

Correspondence Address: KANESAKA BERNER AND PARTNERS LLP, 1700 DIAGONAL RD, SUITE 310, ALEXANDRIA, VA, 22314-2848, US

(73) Assignee: MITSUBISHI HEAVY INDUSTRIES, LTD., Tokyo (JP)

(21) Appl. No.: 12/597,507

(22) PCT Filed: Jul. 25, 2007
(86) PCT No.: PCT/JP2007/064563

§ 371 Date: Dec. 2, 2009

(30) Foreign Application Priority Data
Apr. 27, 2007 (JP) 2007-119654

(51) Int. Cl. B41F 7/02; B41F 3/34

(52) U.S. Cl. 101/217; 101/492

(57) ABSTRACT

The present invention relates to a printing method by an offset printing press and an offset printing press and has an object to carry out a substrate process for low-whiteness printing paper such as paper for newspaper with substrate treatment agent and to enhance the print quality while preventing appearance of muddiness in printing ink by the substrate treatment agent. The present invention is configured such that substrate treatment agent such as low-whiteness enhancement agent is supplied to a printing face of printing paper, and thereafter the substrate treatment agent supplied to the printing face is dried and then offset printing is carried out for the printing paper by a printing apparatus.

### TECHNICAL FIELD

The present invention relates to a printing method by an offset printing press and an offset printing press suitable for use with a newspaper rotary press and printing by a newspaper rotary press.

### BACKGROUND ART

In recent years, the print quality of a picture of a color photograph or the like has been enhanced drastically. Not only enhancement of a printing technique and enhancement of the quality of printing ink but also enhancement of the quality of printing paper contributes much to the enhancement of the print quality. Conversely speaking, there is the possibility that, where printing paper is limited, for example, as in newspaper printing, required printed picture quality may not be sufficiently obtained.

In particular, the whiteness (or brightness) of printing paper for newspaper for use with a newspaper rotary press is lower than that of the other printing paper. Further, in the case of printing paper for newspaper, featherweight paper having low grammage is used taking the transportability into consideration, and still more reduction in weight of paper is advancing in response to a flow of increase of pages. Therefore, the opacity of the paper also drops in comparison with that of the other printing paper.

While such a fact that the whiteness, opacity and so forth of the paper for newspaper are reduced as described above does not make a significant obstacle to printing of an article region, it gives rise to a fault in the case of color printing regarding a color photograph or the like or in a case wherein there is a high line rate printing region over a certain degree of wideness. In particular, since white color of paper itself is utilized in color printing, if the whiteness of paper is low, then a color tone different from a required color tone is obtained at least at the low-whiteness region. Further, if the opacity of the paper is low, then strike-through is likely to appear on the reverse side of the high line rate printing region.

Therefore, in the case of the newspaper printing, a countermeasure for a region which cannot satisfy a request for a white region or another region in which strike-through is likely to appear in normal paper for newspaper as described above is taken by replacement of the printing paper with paper having high whiteness or paper having high opacity.

However, since, in the case of paper for newspaper having high whiteness, in order to enhance the whiteness of the paper for newspaper, the paper is produced by carrying out fine coating or application of white material at a stage of papermaking, the price increases and this increases the cost. Particularly, if the replacement of the paper is carried out as described above, then, for example, paper of a high price having high whiteness is used in regard to the reverse face for which replacement of paper is not required and also in regard to a region on the same face for which replacement of paper is not required such as an article region.

On the other hand, in Patent Document 1, a technique is proposed wherein, where characters and a photograph are printed on the same printing field using paper having low smoothness, low opacity and low whiteness such as paper for newspaper, by carrying out printing after printing field improvement agent for enhancing the smoothness, opacity and whiteness is partially processed in a photograph printing region on the printing field, a photograph is printed clearly while paper for newspaper is used.

Further, in Patent Document 2, a technique is proposed wherein, for normal paper for newspaper having low whiteness, white-based ink is placed and processed in a region in which a photograph or advertisement is to be printed and then printing is carried out so that an advertisement, a photograph or the like is printed with a required color tone while the paper for newspaper is used.

Patent Document 1: Japanese Patent Publication No. Sho 45-25649

Patent Document 2: Japanese Patent Laid-Open No. Hei 2-117877

### DISCLOSURE OF INVENTION

### Subject to be Solved by the Invention

However, in the techniques disclosed in Patent Documents 1 and 2, there is the possibility that cost reduction may be implemented in comparison with an alternative technique wherein printing paper is replaced partially with printing paper having high whiteness. When the process of printing paper is carried out offline in advance, these techniques would be meaningless since printing paper time or the processing cost would be additionally required. The process of printing paper needs to be carried out online. However, the process of printing paper online is not practically available as yet. It is considered that, if paper (web) before printing is processed with paper improvement agent or white-based ink is placed on the paper, then since the paper improvement agent or the white type ink is hard to dry, a fault appears that muddiness occurs in ink transferred by later printing, and the print quality to be enhanced degrades on the contrary.

It is to be noted that the drying of the paper improvement agent, the white-based ink or the like here signifies that, at a stage at which printing is started in a printing section of a printing press, a situation that at least substrate treatment agent on a printing field is not mixed with printing ink transferred by the printing section to cause muddiness in the printing ink is established. A solvent component contained in a substrate treatment agent need not necessarily be eliminated completely from a substrate treatment layer on the printing paper by infiltration into the printing paper or by vaporization into the atmosphere.

In particular, normally in offset printing such as newspaper printing, while ink colors sometimes overlap with each other, overlapping amount of the ink colors is not so large. Therefore, even if new ink is placed on old ink before the old ink is sufficiently dried, a great fault does not occur. However, where next ink is placed on old printing field improvement agent or ink by solid printing or at a high line rate, if the new ink is placed before the paper improvement agent or the ink printed first is completely dried, the printing field improvement agent printed first and the new ink are mixed with each other to cause muddiness. Therefore, the printed color tone degrades significantly. Particularly, if white ink and the other ink are mixed with each other, then the color tone varies significantly.

The present invention has been made in view of such a subject as described above, and it is an object of the present invention to provide a printing method by an offset printing press and an offset printing press wherein a substrate process can be performed for low-whiteness printing paper such as paper for newspaper or like paper using substrate treatment agent and appearance of muddiness in printing ink can be prevented by the substrate treatment agent thereby to improve the print quality.

### Means for Solving Subject

In order to attain the object described above, according to an aspect of the present invention, there is provided a printing method by an offset printing press, comprising the steps of a substrate treatment agent supplying step of supplying substrate treatment agent to a printing face of printing paper, a drying step of drying the substrate treatment agent supplied to the printing face at the substrate treatment agent supplying step, and a printing step of carrying out offset printing for the printing paper dried at the drying step.

Preferably, the substrate treatment agent is a liquid material having viscosity of 0.01 to 50 P in a temperature state of 20° C. at atmospheric pressure and contains solvent which has viscosity of 5 cP or less and vapor pressure of 1 mmHg or more in a temperature state of 20° C. at atmospheric pressure.

Preferably, the drying step includes two processing steps of an infiltration process for infiltrating the printing paper with the solvent contained in the substrate treatment agent and a volatilization process for volatilizing the solvent into the atmosphere.

Preferably, at the drying processing step, the substrate treatment agent is dried by a heating apparatus.

Preferably, at the substrate treatment agent supplying step, the substrate treatment agent is supplied to the printing face by transfer by a printing system.

In this instance, preferably, at the substrate treatment agent supplying step, the substrate treatment agent is printed on the printing face in a predetermined halftone dot shape. In particular, while the substrate treatment agent may be supplied to a printing face with solid printing, it is preferable to supply the substrate treatment agent to a printing face not with solid printing but in a suitable halftone dot shape.

Preferably, at the substrate treatment agent supplying step, the substrate treatment agent is supplied to part of the printing face so as to include a printing location of a photograph or advertisement portion on the printing face.

According to another aspect of the present invention, there is provided an offset printing press for carrying out offset printing on printing paper, comprising a substrate treatment agent supplying apparatus provided on the upstream side with respect to a blanket drum nip section for a first color of a printing apparatus and including a substrate treatment agent supplying section adapted to supply substrate treatment agent to a printing face of the printing paper, and wherein the substrate treatment agent supplying apparatus includes a drying processing section provided on the downstream side of the substrate treatment agent supplying section and adapted to carry out a drying process for the substrate treatment agent supplied to the printing face.

It is to be noted that the offset printing press according to the present invention can be applied, for example, to a commercial offset rotary press (commercial press) or a newspaper rotary press. While, as a rotary press just described above, a rotary press for printing with a nip between two blanket drums is mainly used, also a rotary press for printing with a nip between a blanket drum and a pressure drum is available. The blanket drum nip section includes also a nip section between blanket drums and another nip section between a blanket drum and a pressure drum.

Preferably, also in the offset printing press, the substrate treatment agent is a liquid material (not only including a liquid material but also including a semi-solid material, wherein a solid material is mixed with a liquid material, such as slurry or the like) having viscosity of 0.01 to 50 P in a temperature state of 20° C. at atmospheric pressure and includes solvent which has viscosity of 5 cP or less and vapor pressure of 1 mmHg or more in a temperature state of 20° C. at atmospheric pressure.

Preferably, the drying process section carries out the drying process by an infiltration process for infiltrating the printing paper with solvent contained in the substrate treatment agent and a volatilization process for volatilizing the solvent into the atmosphere.

Preferably, the drying processing section includes a heating apparatus adapted to heat and dry the substrate treatment agent.

Preferably, the printing paper is low-whiteness printing paper and the offset printing press is configured as a rotary press, and the substrate treatment agent supplying apparatus is disposed, within a range from a paper supplying section to a blanket drum nip section for a first color of the printing apparatus, on the downstream side with respect to an apparatus for varying a web path length to the first color blanket drum nip section and on the upstream side with respect to the first color blanket drum nip section.

It is to be noted that the apparatus for varying the web-path length is, for example, a floating roller for absorbing variation of paper supplying tension, a dancer roller for controlling tension at an entrance of a printing unit or the like.

Preferably, the substrate treatment agent supplying apparatus transfers and supplies the substrate treatment agent to the printing face by a printing system.

In this case, preferably, the substrate treatment agent supplying apparatus prints the substrate treatment agent on the printing face with a high tone value higher than a predetermined halftone dot value.

Preferably, the substrate treatment agent supplying apparatus supplies the substrate treatment agent to part of the printing face so as to include a printing location of a photograph or advertisement on the printing face.

It is to be noted that, preferably in the printing method by an offset printing press and the offset printing press, the printing paper is low-whiteness printing paper (in particular, paper for newspaper) and the offset printing press is a newspaper rotary press.

Preferably, the substrate treatment agent is whiteness enhancement agent.

In this case, preferably, the whiteness enhancement agent is white ink.

Or, preferably, the substrate treatment agent is specific color ink of an ink color other than basic ink colors of cyan, magenta and yellow and ink colors of white and black.

Further, as the substrate treatment agent, aqueous agent or oily agent may be used.

### EFFECT OF THE INVENTION

With the printing method by an offset printing press and the offset printing press of the present invention, the substrate treatment agent is supplied to a printing face of the printing paper and the substrate treatment agent on the printing face is dried, and thereafter, offset printing is carried out for the printing paper. Therefore, a bad influence of a substrate process such as appearance of muddiness in ink by mixture of ink transferred after the substrate process and the substrate treatment agent with each other is prevented and printing is carried out favorably on the printing face for which the substrate process is carried out.

Further, by using a liquid material having viscosity of approximately 0.01 to 50 P in a temperature state of 20° C. under the atmospheric pressure as the substrate treatment agent, the substrate treatment agent can be suitably supplied where it is transferred and supplied to the printing face of the printing face, for example, through a roller. In particular, there is the possibility that, if the viscosity of the substrate treatment agent becomes higher than approximately 50 P, then, since the substrate treatment agent becomes too hard, it is difficult to transfer the ink through the roller. On the contrary, there is the possibility that, if the viscosity of the substrate treatment agent becomes lower than, for example, the viscosity of approximately 0.01 P which corresponds to that of water, then the transportability of the substrate treatment agent by the roller degrades and supplying of the substrate treatment agent becomes difficult.

Further, by containing a solvent having viscosity of approximately 5 cP or less and a vapor pressure of 1 mmHg or more in a temperature state of 20° C. under the atmospheric pressure into the substrate treatment agent, the substrate treatment agent can be easily dried before the printing ink is transferred to the printing face of the printing paper.

Further, by carrying out the drying process by an infiltration process for infiltrating the printing paper with the solvent contained in the substrate treatment agent and a vaporization process for vaporizing the solvent into the atmosphere, drying of the substrate treatment agent can be achieved promptly.

Further, where the offset printing press is a newspaper rotary press in which paper for newspaper which is low-whiteness printing paper is used as printing paper, it is sometimes difficult to print due to paper quality of the paper, for example, a full-color photograph or an advertisement for which the requirement regarding the color tone is severe so as to have a target color tone. However, by carrying out the substrate process so as to prevent appearance of muddiness in ink, the printing with the target color which has been difficult can be carried.

For example, by using whiteness improvement agent such as white ink as the substrate treatment agent, the whiteness of the low-whiteness printing paper can be enhanced and the printing with the target color can be carried out also where the color tone requirement is severe.

Further, by using specific color ink of ink colors other than basic ink colors of cyan, magenta and yellow and ink colors of white and black, for example, an advertisement or the like can be represented with an impressive color shade.

Further, by positively drying the substrate treatment agent by a heating apparatus, the substrate treatment agent can be dried still more promptly, and the drying by the heating apparatus is particularly suitable for high speed printing.

Further, where the present invention is applied to a rotary press in which low-whiteness printing paper is used as the printing paper, by disposing the substrate treatment agent supplying apparatus at a location on the downstream side with respect to an apparatus for varying the web-path length from the paper supplying section to a first-color blanket drum nip section of the printing apparatus and on the upstream side with respect to the first-color blanket drum nip section, the substrate treatment agent can be supplied in an associated relationship with the phase of printing paper in the printing apparatus on the downstream side, and, for example, the substrate process can be easily carried out only for a predetermined region of the printing paper.

Further, by transferring and supplying the substrate treatment agent to the printing face with a printing system, it becomes easy to carry out the substrate process, and it also becomes easy to carry out the substrate process only for a predetermined region of the printing paper.

In this instance, if the substrate treatment agent is printed on the printing face in a predetermined halftone dot shape, then the substrate treatment agent can be supplied with a suitable density.

If the substrate treatment agent is supplied to part of the printing face so as to include a printing region of a photograph or an advertisement on the printing face, then the substrate process can be carried out efficiently and the processing cost can be suppressed. Further, there is also a case wherein, in a printing field on which articles and photographs or advertisements are printed in a mixed relationship with each other, the article region can be read rather easily in a case wherein the substrate process is not carried out therefor, and the present invention can be coped easily with such a case as described above.

### BRIEF DESCRIPTION OF THE DRAWINGS

FIG. 1 is an explanatory view showing a configuration of essential part of an offset printing press according to a first embodiment of the present invention.

FIGS. 2(a) and 2(b) are conceptual views relating to drying of substrate treatment agent according to embodiments of the present invention, and wherein FIG. 2(a) illustrates the drying in a state before drying of the substrate treatment agent and FIG. 2(b) illustrates the drying in another state after advancement of the drying of the substrate treatment agent.

FIG. 3 is a view illustrating a relationship between the viscosity of solvent contained in the substrate treatment agent and the infiltration speed into paper according to the embodiments of the present invention.

FIG. 4 is a view illustrating a relationship between the viscosity and the vapor pressure of the solvent contained in the substrate treatment agent according to the embodiments of the present invention.

FIG. 5 is a front elevational view showing a printing face of paper for newspaper according to the first embodiment of the present invention.

FIG. 6 is a flow chart illustrating a printing method by the offset printing press according to the first embodiment of the present invention.

FIG. 7 is a view showing a configuration of essential part of an offset printing press according to a second embodiment of the present invention.

FIG. 8 is a view showing a configuration of essential part of an offset printing press according to a third embodiment of the present invention.

Description of Reference Characters

| | |
|---|---|
| 1 | paper supplying section |
| 1a | roll paper |
| 2 | in-feed section |
| 2a | in-feed roller |
| 2b | dancer roller |
| 3a, 3b, 3c | guide roller |
| 4 | substrate treatment agent supplying apparatus |
| 4A | substrate treatment agent processing section |
| 4B | drying processing section |
| 4a, 4c | substrate treatment agent supplying roll |
| 4b, 4d | printing drum |
| 5 | heating apparatus |
| 6 | printing section (printing apparatus) |
| 7 | floating roller |
| 10 | paper (web) for newspaper as printing paper |
| 11a, 11b | printing face (printing page) |
| 12 | region in which article is printed |
| 13 | printing region of photograph |
| 14, 15 | printing region of advertisement |

### BEST MODE FOR CARRYING OUT THE INVENTION

In the following, embodiments of the present invention are described with reference to the drawings.

### First Embodiment

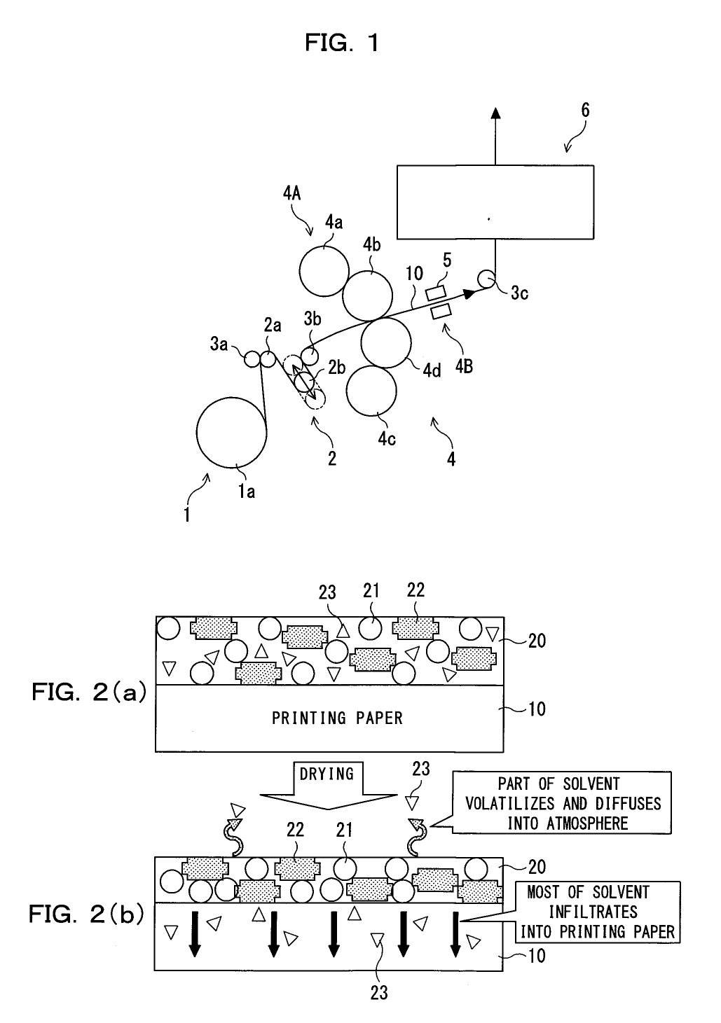

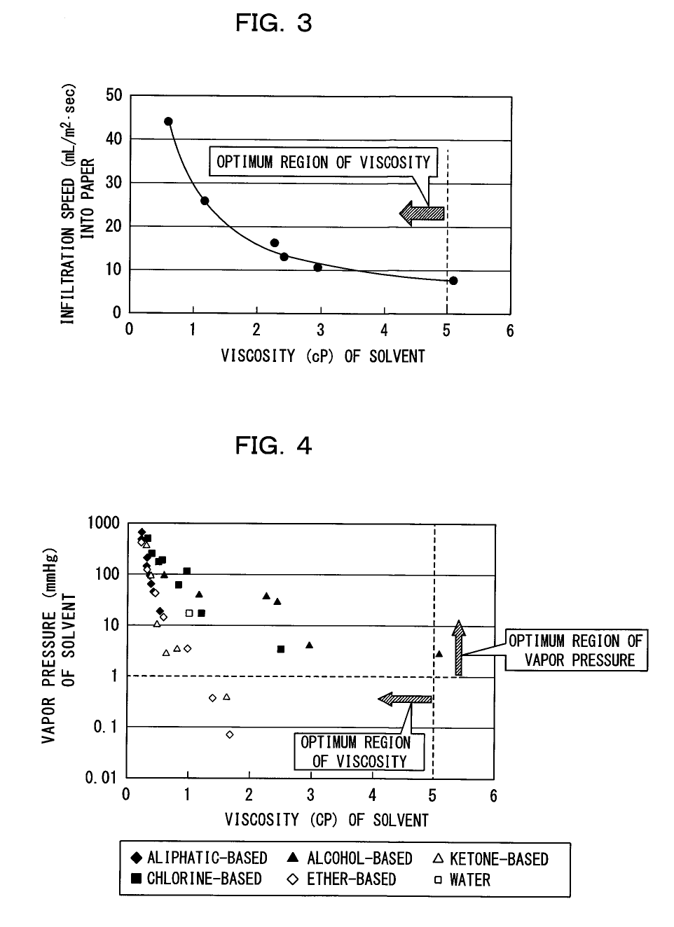

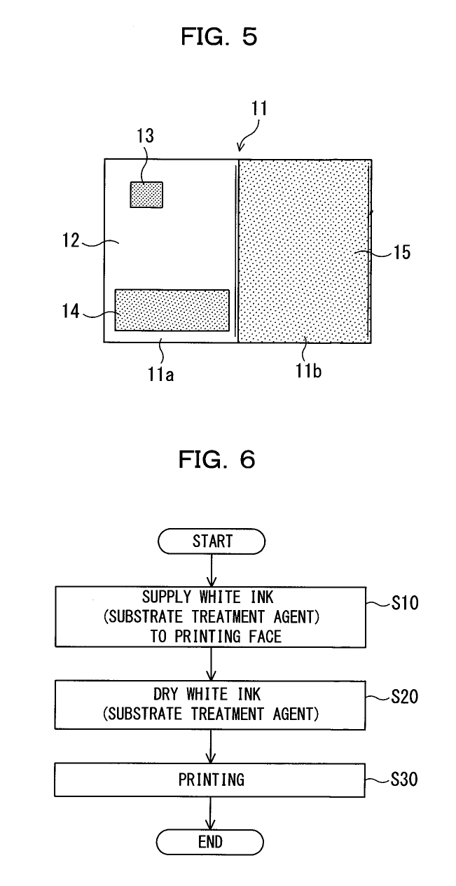

First, a first embodiment of the present invention is described. FIGS. 1 to 6 illustrate the first embodiment of the present invention, and wherein FIG. 1 is an explanatory view showing a configuration of essential part of an offset printing press of the present embodiment and FIG. 2 is a conceptual view relating to drying of a substrate treatment agent for the offset printing press. Further, FIG. 3 is a view illustrating a relationship between the viscosity and the infiltration speed into paper of solvent contained in the substrate treatment agent and FIG. 4 is a view illustrating a relationship between the viscosity and the vapor pressure of the solvent contained in the substrate treatment agent. Further, FIG. 5 is a front elevational view showing a printing face of the paper for newspaper and FIG. 6 is a flow chart illustrating a printing method by the offset printing press.

The present embodiment relates to a newspaper rotary press as the offset printing press, and, as shown in FIG. 1, a substrate treatment agent supplying apparatus 4 for supplying a substrate treatment agent to a printing face of paper 10 for newspaper (hereinafter referred to sometimes as web) in a web state (in a state of continuous form paper) to be printed is added on the upstream side of a printing section (printing apparatus) 6 of the newspaper rotary press. Here, since the present embodiment is described taking a case wherein white ink is used as the substrate treatment agent as an example, the substrate treatment agent supplying apparatus is referred to sometimes as a white ink supplying apparatus 4. It is to be noted that, while, for example, general paper having whiteness of 54 to 55% and grammage of approximately 42 to 44 g/m² is used as the paper (web) 10 for newspaper, the paper (web) 10 for newspaper is not limited to this.

In particular, the newspaper rotary press transports the web 10 installed as roll paper 1a in a paper supplying section 1 and delivered from the in-feed section 2 to the printing section 6 and transfers required color ink by means of a printing unit (not shown) provided on the printing section 6 and then outputs the web 10 as a folded document through a cooling section, a web-path section and a folding machine (not shown).

The in-feed section 2 includes an in-feed roller 2a, a dancer roller 2b for adjusting the tension of the web 10 by movement thereof to change the web-path distance, a guide roller 3a disposed in an opposed relationship with the in-feed roller 2a across the web 10, and delivers the web 10 toward the printing section 7 while maintaining the state of the web 10 in a set state.

It is to be noted that, while a single printing unit is provided in the printing section 6 in a case of single-color printing, a plurality of printing units are provided here so as to carry out multi-color printing such as full-color printing or the like.

The substrate treatment agent supplying apparatus 4 is added to a location on the downstream side with respect to the dancer roller 2b which is an apparatus for varying the web-path length of the in-feed section 2 in an existing newspaper rotary press but on the upstream side with respect to a first-color blanket drum nip section (not shown) of the printing apparatus (here, on the upstream side with respect to the location of a guide roller 3c at an entrance of the printing section 6).

It is to be noted that, while the present embodiment is configured such that the white ink supplying apparatus 4 as the substrate treatment agent supplying apparatus is added to an existing printing press, it is a possible idea that, as a configuration for utilizing an existing printing press still more effectively, the guide roller 3b shown in FIG. 1 is used in place of a pressure drum of the substrate treatment agent supplying apparatus.

The substrate treatment agent supplying apparatus (white ink supplying apparatus) 4 includes a substrate treatment agent processing section (white ink supplying section) 4A and a drying processing section 4B.

The substrate treatment agent supplying section 4A is configured similarly to a popular printing unit for offset printing and includes substrate treatment agent supplying rolls 4a and 4c for supplying the substrate treatment agent to a printing plate and printing drums 4b and 4d on which the printing plate is mounted corresponding to a printing region of the substrate treatment agent. Further, as occasion demands, a printing drum may be provided at the position of the substrate treatment agent supplying rolls 4a and 4c and a transfer drum for transferring the substrate treatment agent received from the substrate treatment agent supplying rolls 4a and 4c to the surface (printing face) of the web 10 may be provided at the position of the printing drums 4b and 4d. As the transfer drum in this instance, a drum corresponding to a blanket drum of a commercial offset rotary press (commercial offset) or a newspaper rotary press may be used.

Here, since the substrate treatment agent is transferred to both faces of the web 10, a first substrate treatment agent supplying system having a substrate treatment agent supplying roll 4a and a printing drum 4b is disposed on one face side of the web 10 and a second substrate treatment agent supplying system having a substrate treatment agent supplying roll 4c and a printing drum 4d is disposed on the other face side of the web 10. Therefore, where the substrate treatment agent is transferred only to one face side of the web 10, the substrate treatment agent supplying system on the unnecessary side may be set so as not to be used or it may be set that the substrate treatment agent supplying system on the unnecessary side is not mounted in advance.

Further, the drying processing section 4B provided on the downstream side in the substrate treatment agent supplying apparatus 4 dries the substrate treatment agent transferred to the printing face of the web 10, and the heating apparatus 5 for heating and drying the substrate treatment agent is provided in the drying processing section 4B in the present embodiment.

It is to be noted that, for the heating apparatus 5, various methods such as a warm air method for drying the web 10 by blowing warm air to the printing face of the web 10, a vapor method for drying the web 10 by blowing high-temperature vapor to the printing face of the web 10, a method for irradiating infrared rays, a combination of the methods just described (all of the methods are non-contacting methods), a high-temperature roll method wherein a high-temperature roll is contacted with the printing face of the web 10 so as to rotate at a circumferential speed synchronized with that of the web 10 or the like can be applied.

Here, heating drying can be carried out not only for the printing face but also for the reverse side to the printing face by all of the warm air method, vapor method, infrared ray irradiation method and high-temperature roll method. Further, where the type of the substrate treatment agent is an energy beam curing type by an electron ray, an ultraviolet ray or the like, the heating apparatus can be configured as a drying apparatus by an electron ray or an ultraviolet ray irradiation.

Particularly since, if high-temperature vapor is suitably used, then a fault of contraction of the web by moisture reduction by heating of the web 10 is prevented, it is preferable to use the high-temperature vapor. For example, it is possible to apply a contacting method for contacting a high-temperature roller with the web, and also it is possible to provide a high-temperature roller separately. Further, also it is possible to dry the web with a contacting method by causing the guide roller 3C to generate heat. Here, a non-contacting method wherein the warm air method and the high-temperature vapor method are mixed with each other is used.

It is to be noted that, for example, for the substrate treatment agent like white ink, the viscosity of 0.01 to 50 P in a reference state (temperature state of 20° C. under the atmospheric pressure) is suitable especially for supplying of the substrate treatment agent using a roller. In particular, if the viscosity becomes higher than approximately 50 P, the substrate treatment agent becomes too hard and transfer of ink through the roller becomes difficult. On the other hand, in order to prevent the transportability of the substrate treatment agent by the roller from degrading to such a degree that supplying of the substrate treatment agent becomes difficult, it is preferable to set a lower limit to the viscosity of the substrate treatment agent, for example, to viscosity of approximately 0.01 P corresponding to that of water.

Now, the characteristic of the solvent in the substrate treatment agent which has an influence on the drying characteristic of the substrate treatment agent is described.

At a drying step, drying is carried out by two steps of an infiltration step (infiltration process) of the solvent contained in the substrate treatment agent into printing paper and a vaporization step (vaporization process) of the solvent into the atmosphere.

FIGS. 2(a) and 2(b) are conceptual views illustrating the drying step of the substrate treatment agent. As seen in FIGS. 2(a) and 2(b), the substrate treatment agent 20 contains at least pigment 21 as a coloring material, binder resin 22 and solvent 23. While a substrate treatment layer formed from the substrate treatment agent 20 contains all of the pigment 21, binder resin 22 and solvent 23 as seen in FIG. 2(a) immediately after the substrate treatment agent is applied to the printing paper 10, the solvent 23 is removed as seen in FIG. 2(b) as the drying step advances.

At the drying step, the drying of the substrate treatment agent is achieved while infiltration of the solvent into the printing paper and diffusion of the solvent into the atmosphere by vaporization advance at the same time. At this time, naturally the drying of the substrate treatment agent is quickly achieved as the printing paper is quickly infiltrated with the solvent and as the solvent is quickly vaporized.

In order to supply the substrate treatment agent to the printing face of the printing paper on the printing press to print an image or characters with printing ink transferred subsequently by the printing section 6, the drying speed of the substrate treatment agent must be sufficiently high and the solvent of the substrate treatment agent is selected so as to assure a high drying speed. As the reference of the selection, the viscosity and the vaporization speed of the solvent at room temperature become the points.

Where there is no great difference in wettability between the solvent and the printing paper, that is, in the case of normal paper for which a water repelling process or the like is not performed, there is a tendency that the infiltration speed of the solvent into the printing paper becomes high as the viscosity of the solvent becomes low as seen in FIG. 3.

It is to be noted that FIG. 3 is a graph illustrating the infiltration speed (solvent infiltration amount into paper in a unit area per one second, ml/m²·sec) of an alcohol-based solvent having a different viscosity into paper as measured by a Bristow type liquid dynamic absorption testing machine of the Kumagai Riki Kogyo Co., Ltd. In more detail, FIG. 3 illustrates a result where paper for newspaper having 25 mm width×1,000 mm length was wound around a sample disk having 25 mm width×318.5 mmφ diameter and solvent of 40 μl was filled into a head box having 15 mm width and 1 mm slit width and then the measurement was carried out at a contacting pressure of 0.1 MPa between the head box and the newspaper and at a disk rotation speed within a range of 1.25 to 250 mm/sec.

In order to reduce the burden on the heating apparatus or the like for drying the substrate treatment agent and complete the drying of the substrate treatment agent at an ordinary temperature and in short time (in a short feeding distance interval of the printing paper), for example, without using the heating apparatus, the infiltration speed into paper is at least 5 ml/m²·sec or more, and preferably 10 ml/m²·sec or more. Further, it can be recognized from FIG. 3 that the viscosity of the solvent at this time is 5 cP or less, and preferably 3 cP or less and more preferably 1 cP or less.

Further, as seen in FIG. 4, there is a tendency that basically the vapor pressure at the room temperature becomes higher and the vaporization speed at the room temperature increases as the viscosity of the solvent decreases.

It is to be noted that FIG. 4 is a graph illustrating a result where solvents which can be used for the substrate treatment agent of the present invention were classified into aliphatic hydrocarbon solvent, chlorine-based hydrocarbon solvent, alcohol-based solvent, ether-based solvent, ketone-based solvent and water and the relationship between the viscosity and the vapor pressure of the solvent under the atmospheric pressure at the room temperature (20° C.) was investigated.

In order to reduce the burden on the heating apparatus or the like for drying the substrate treatment agent and complete the drying of the substrate treatment agent at an ordinary temperature and in short time (in a short driving distance interval of the printing paper), for example, without using the heating apparatus, it can be recognized from FIG. 4 that preferably the vapor pressure of the solvent is at least 1 mmHg or more, preferably 10 mmHg or more and more preferably 50 mmHg or more.

Accordingly, in order to achieve that [the substrate treatment agent such as white ink is dried before printing ink is transferred to the printing paper (web) by the printing section 6] which is the subject of the present invention, the viscosity and the vapor pressure of the solvent suitably used in the substrate treatment agent in the present invention are 5 cP or less and 1 mmHg or more under the atmospheric pressure in a 20° C. temperature state, respectively. Preferably, the viscosity and the vapor pressure of the solvent are 3 cP or less and 10 mmHg or more under the atmosphere pressure in a 20° C. temperature state, respectively. More preferably, the viscosity and the vapor pressure of the solvent are 1 cP or less and 50 mmHg or more under the atmosphere pressure in a 20° C. temperature state, respectively. Naturally, the combination of optimum regions of the viscosity and the vapor pressure is not limited to this, and the viscosity may be limited more strictly or the vapor pressure may be limited more strictly.

It is to be noted that the drying state in the present invention signifies a state wherein at least the substrate treatment agent on the printing field is not mixed with the printing ink transferred by the printing section 6 to such degree that muddiness appears in the printing ink, and all of the solvent within the substrate treatment agent need not be transferred from the substrate treatment layer on the printing field to the printing paper or into the atmosphere. Accordingly, the solvent for enhancing the drying characteristic may be contained by 1 to 30% by weight in the substrate treatment agent. Where the content of the solvent just described is 1% or less, the effect of the drying characteristic enhancement is not developed. On the other hand, there is the possibility that, where the content of the solvent described above is 30% or more, a fault may appear that the speed of drying, particularly vaporization, becomes excessively high to such a degree that handling of the substrate treatment agent on the printing press becomes difficult.

Further, in order to apply other characteristics required for the substrate treatment agent such as transfer characteristic, picture quality, maintenance characteristic, storage stability and safety, as occasion demands, not only solvent for enhancing the drying characteristic but also different solvent having a viscosity of 5 cP or more and a vapor pressure of 1 mmHg or less under the atmospheric pressure at 20° C. may be contained by a suitable amount.

It is to be noted that, as indicated by printed and cut newspaper 11 in FIG. 5, supplying of the substrate treatment agent to the web 10 by the substrate treatment agent supplying apparatus 4 is carried out only at a predetermined location (here, a printing region 13 of a photograph and printing regions 14 and 15 of an advertisement) on the printing faces (printing pages) 11a and 11b. It is to be noted that white ink may be used as an example of the substrate treatment agent to be supplied to the newspaper 11. The white ink is not supplied to a region 12 in which an article is to be printed. In particular, a printing plate for white ink ready for the required regions 13, 14 and 15 is prepared and is mounted on the printing drums 4b and 4d to carry out printing so that such a process as described above can be carried out.

It is to be noted that, while a printing region may be set as a solid printing region (100% tone value) on a printing plate for white ink, basic ink or special color ink, the printing region may be set also as a region which has an arbitrary halftone dot shape different from solid printing. In this instance, the drying speed of each ink can be raised while enhancement of the whiteness of the printing face of the web 10 or the optical density of ink is implemented to some degree.

Further, as described above, the white ink supplying apparatus 4 is provided at a location on the downstream side with respect to the dancer roller 2b which is an apparatus for varying the web-path length of the in-feed section 2 but on the upstream side with respect to the first color blanket drum nip section of the printing apparatus. Therefore, the phase of the printing plate for white ink can be easily adjusted to that of each printing plate in the printing section 6, and such printing of white ink to the required regions 13, 14 and 15 as described above can be carried out with certainty.

Since the newspaper rotary press as the offset printing press according to the first embodiment of the present invention is configured as described above, printing on the surface (printing face) of the web 10 is carried out as illustrated in the flow chart of FIG. 6.

In particular, white ink (substrate treatment agent) is first supplied to the printing face of the web 10 supplied from the paper supplying section 1 while the tension state thereof is adjusted by the in-feed section 2 by the white ink supplying section 4A of the white ink supplying apparatus 4 (step S10; substrate treatment agent supplying step). The supplying of the white ink is carried out only for the required regions 13, 14 and 15 (FIG. 5) by a printing system.

Then, the web 10 advances to the drying processing section 4B and the white ink (substrate treatment agent) on the printing face is subjected to a heating drying process by the heating apparatus 5 (step S20; drying step). Then, the printing is carried out by the printing section 6 (step S30; printing step).

As described above, at the stage at which the white ink on the printing face is subjected to the drying process and the printing is started by the printing section 6, a state is implemented wherein the white ink is not mixed with the printing ink transferred by the printing section 6 to such a degree that muddiness appears in the printing ink. Therefore, the printing is carried out without causing muddiness in the printing ink.

Consequently, the surface of the paper (web) 10 for newspaper having the low whiteness is processed with the white ink so as to have high whiteness and then a photograph (printing region 13 in FIG. 5) and advertisements (printing regions 14 and 15 in FIG. 5) of full colors are printed on the processed surface of the web 10 without causing muddiness in the printing ink such that printing having a color tone to be reproduced can be implemented utilizing the substrate having the high whiteness. Regarding the photograph, it can be printed while correctly reproducing a subject copy, and, regarding the advertisements, for example, the printing can be carried out while correctly reproducing a subject copy and clearer printing having a high advertisement effect can be implemented.

Particularly, since the white ink is supplied only to a photograph region or an advertisement region on the printing face, that is, to part of the printing face, the substrate process can be carried out efficiently and the processing cost can be suppressed. Further, the article region 12 can be read rather clearly when the substrate process is not carried out therefor.

### Second Embodiment

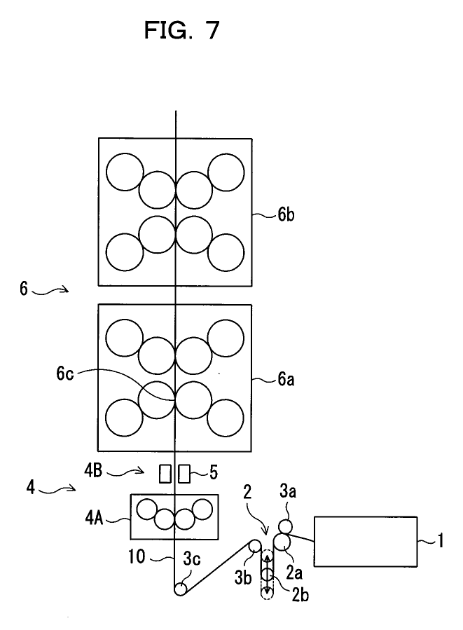

Now, a second embodiment of the present invention is described. FIG. 7 is an explanatory view showing a configuration of essential part of an offset printing press in the second embodiment of the present invention. In FIG. 7, like elements to those in FIG. 1 are denoted by like reference characters and description of the like elements is partly omitted.

While the first embodiment is configured such that the substrate treatment agent supplying apparatus (substrate treatment agent supplying section 4A and drying processing section 4B) 4 is added to an existing newspaper rotary press, the present embodiment is configured such that the substrate treatment agent supplying apparatus 4 is incorporated originally in a newspaper rotary press. In particular, as shown in FIG. 7, the substrate treatment agent supplying apparatus 4 is mounted on the upstream side of the printing section 6 including printing units 6a and 6b and so forth in a juxtaposed relationship with the printing section 6. The configuration of the other part of the present embodiment is similar to that of the first embodiment. It is to be noted that, in the present embodiment, description is given taking a case wherein white ink is used as the substrate treatment agent as an example.

It is to be noted that, also in the present embodiment, similarly as in the first embodiment, the white ink supplying apparatus 4 is provided on the downstream side with respect to the dancer roller 2b which is an apparatus for varying the web-path length of the in-feed section 2 (here, however, on the downstream side with respect to the guide roller 3c for guiding the web 10 to the printing apparatus 6) but on the upstream side with respect to the blanket drum nip 6c of the first printing unit 6a of the printing apparatus 6. Therefore, the phase of a printing plate for the white ink can be easily adjusted to that of each printing plate in the printing section 6, and printing of the white ink to the required regions 13, 14 and 15 described in the first embodiment can be carried out with certainty.

Also with such a configuration as described above, similarly to the first embodiment, an effect is achieved that printing can be carried out with printing ink without causing muddiness or the like by the white ink in the printing ink and printing having a color tone to be reproduced can be implemented utilizing the substrate having the high whiteness.

### Third Embodiment

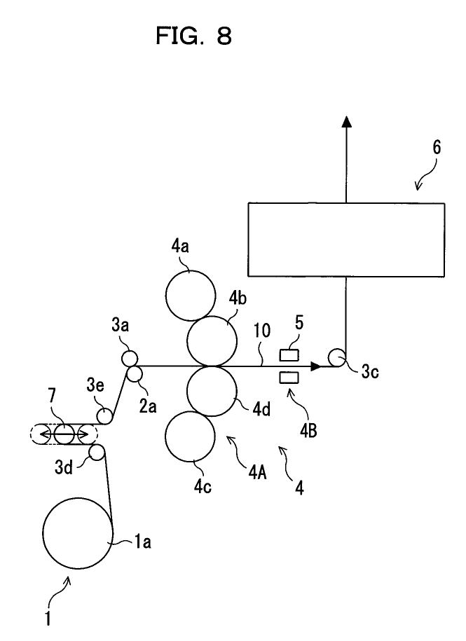

Now, a third embodiment of the present invention is described. FIG. 8 is an explanatory view showing a configuration of essential part of an offset printing press in the first embodiment of the present invention. In FIG. 8, like elements to those in FIG. 1 are denoted by like reference characters, and description of the like elements is partly omitted. Also in the present embodiment, description is given taking a case wherein white ink is used as the substrate treatment agent as an example.

In the present embodiment, while the substrate treatment agent supplying apparatus 4 itself is same as those in the first and second embodiments, a portion of the printing press on the upstream side with respect to the substrate treatment agent supplying apparatus 4 is different from those in the first and second embodiments.

In particular, while the dancer roller is provided as an apparatus for varying the web-path length in the first and second embodiments, in the present embodiment, the dancer roller is not provided but a floating roller 7 is provided as an apparatus for varying the web-path length as shown in FIG. 8.

The floating roller 7 is an apparatus for absorbing variation of paper supplying tension, and if the paper supplying tension decreases upon speed up or down, pasting, emergency shutdown or the like of the rotary press, then the movement tension decreasing amount is absorbed in a direction to the left side (refer to alternate long and two short dashes line) in FIG. 8. On the contrary, if the paper supplying tension increases, then the movement tension increasing amount is absorbed in a direction toward the right side (refer to alternate long and two short dashes line) in FIG. 8.

It is to be noted that the dancer roller 2b and the in-feed roller 2a (refer to FIGS. 1 and 7) described in connection with the first and second embodiments positively detect the tension at the entrance of the printing unit and change the position of the dancer roller 2b and the circumferential speed of the in-feed roller 2a to suppress the tension variation and then stabilize the tension at the entrance of the printing unit. Further, while the dancer roller 2b and the in-feed roller 2a include a driving apparatus for driving the dancer roller 2b, the floating roller 7 does not specifically include a driving apparatus (floating roller 7 is a mere pendulum roller) and is an apparatus for absorbing tension variation. However, the floating roller 7 is common to the dancer roller 2b and the in-feed roller 2a in that it is an apparatus for varying the web-path length.

Accordingly, where the substrate process such as supplying of white ink is carried out for a required location of the web 10, the white ink supplying apparatus (substrate treatment agent supplying apparatus) 4 is disposed on the downstream side with respect to the floating roller 7 which is an apparatus for varying the web-path length in order to prevent displacement of the phase of the printing position, for which the substrate process is carried out, caused by variation of the web-path length.

Also with such a configuration as just described, similarly as in the first and second embodiments, an effect is achieved that printing can be carried out without causing muddiness or the like by the white ink in the printing ink and printing having a color tone to be reproduced can be implemented utilizing the substrate having the high whiteness.

It is to be noted that, where there are a plurality of [apparatus for varying the web-path length], it is preferable to dispose the white ink supplying apparatus (substrate treatment agent supplying apparatus) 4 on the downstream side with respect to the [apparatus for varying the web-path length] disposed on the more downstream side with respect to the paper supplying section toward the first color blanket drum nip section.

### [Others]

While the embodiments of the present invention are described above, the present invention is not limited to the configurations specifically described above, and variations and modifications can be made without departing from the scope of the present invention.

For example, while a newspaper rotary press is taken as an example in the foregoing description of the embodiments, the present invention can be widely applied not only to a newspaper rotary press but also to an offset printing press.

Further, while the white ink is used as the substrate treatment agent, also in a case wherein the whiteness is enhanced, whiteness enhancement agent different from white ink such as, for example, decoloring agent or the like may be used. Where decoloring agent is used, since a cleaning step is difficult to carry out on a printing press, it is required that the decoloring agent be an agent which itself sublimates (or vaporizes) together with coloring components of newspaper.

Further, printing paper which is a target for which the substrate process is to be carried out is not limited to low-whiteness printing paper such as paper for newspaper. Naturally, also the substrate treatment agent is not limited to whiteness enhancement agent. An agent for enhancing the smoothness on the surface of paper such as, for example, transparent ink (for example, varnish or the like), ink containing, for example, metal components, an agent for enhancing the brightness (different from whiteness) such as reflectance enhancement agent can be applied as the substrate treatment agent in the present invention.

Further, it is a possible idea to use, as the substrate treatment agent, specific color ink other than white ink, that is, specific color ink of ink colors of basic color ink of cyan, magenta and yellow and ink colors of white and black. If the specific color ink is applied to the substrate in such a manner as described above, then representation variation of the color shade increases significantly and color development having very high impression can be implemented. Therefore, particularly by applying such specific color ink as described above to an advertisement, the present invention can contribute to enhancement of the advertisement effect.

Further, a plurality of kinds of substrate treatment agent may be used. In particular, a plurality of substrate treatment agent supplying apparatus such as a white ink supplying apparatus 4 as described above are provided such that the substrate treatment agent supplying apparatus individually carry out substrate processes different from each other. Consequently, for example, a substrate process for the enhancement of the whiteness and the enhancement of the brightness of the other colors, surface smoothing or the like can be carried out for the same printing field, and the present invention can satisfy various requests for printing.

Further, while the white ink (substrate treatment agent) is supplied to all regions regarding the photograph region or the advertisement region on the printing face in the embodiments described above, the white ink (substrate treatment agent) may be partly supplied only to a necessary region in the photograph region or the advertisement region. In particular, the substrate process is not carried out for a region wherein the substrate is little exposed. Consequently, the substrate process can be carried out with higher efficiency and the processing cost can be suppressed still more. It is to be noted that, also in this instance, it is preferable to secure a rather great contour for the substrate process to carry out the substrate process also for a boundary portion of a region wherein the substrate is little exposed by the ink thereby to prevent exposure of the region for which the substrate process is not carried out.

Further, while the heating apparatus 5 is provided in the drying processing section 4B in the embodiments described above, where the substrate treatment agent such as white ink which has a quick-drying characteristic and dries at the room temperature and in a short period is used, as a particular example of the drying processing section 4B, the drying processing section 4B can be also set as a mere space in which the heating apparatus 5 is not provided, that is, as a natural drying (or room temperature drying) interval.

### INDUSTRIAL APPLICABILITY OF THE INVENTION

The present invention can be used for an apparatus for carrying out printing on low-whiteness printing paper such as paper for newspaper to enhance the print quality, and the present invention can be widely applied to a printing method by an offset printing press and an offset printing press.

1. A printing method by an offset printing press, comprising the steps of:
a substrate treatment agent supplying step of supplying substrate treatment agent to a printing face of printing paper;
a drying step of drying the substrate treatment agent supplied to the printing face at the substrate treatment agent supplying step; and
a printing step of carrying out offset printing for the printing paper dried at the drying step.

2. The printing method by an offset printing press as claimed in claim 1, wherein the substrate treatment agent is a liquid material having viscosity of 0.01 to 50 P in a temperature state of 20° C. at atmospheric pressure and contains solvent which has viscosity of 5 cP or less and vapor pressure of 1 mmHg or more in a temperature state of 20° C. at atmospheric pressure.

3. The printing method by an offset printing press as claimed in claim 1, wherein the drying step includes two processing steps of an infiltration process for infiltrating the printing paper with the solvent contained in the substrate treatment agent and a volatilization process for volatilizing the solvent into the atmosphere.

4. The printing method by an offset printing press as claimed in claim 1, wherein the printing paper is low-whiteness printing paper, and
the offset printing press is a newspaper rotary press.

5. The printing method by an offset printing press as claimed in claim 1, wherein the substrate treatment agent is whiteness improvement agent.

6. (canceled)

7. (canceled)

8. The printing method by an offset printing press as claimed in claim 1, wherein the substrate treatment agent is an aqueous agent.

9. (canceled)

10. The printing method by an offset printing press as claimed in claim 1, wherein, at the drying processing step, the substrate treatment agent is dried by a heating apparatus.

11. (canceled)

12. (canceled)

13. (canceled)

14. An offset printing press for carrying out offset printing on printing paper, comprising:
a substrate treatment agent supplying apparatus provided on the upstream side with respect to a blanket drum nip section for a first color of a printing apparatus and including a substrate treatment agent supplying section adapted to supply substrate treatment agent to a printing face of the printing paper; and wherein
the substrate treatment agent supplying apparatus includes a drying processing section provided on the downstream side of the substrate treatment agent supplying section and adapted to carry out a drying process for the substrate treatment agent supplied to the printing face.

15. The offset printing press as claimed in claim 14, wherein the substrate treatment agent is a liquid material having viscosity of 0.01 to 50 P in a temperature state of 20° C. at atmospheric pressure and includes solvent which has viscosity of 5 cP or less and vapor pressure of 1 mmHg or more in a temperature state of 20° C. at atmospheric pressure.

16. The offset printing press as claimed in claim 14, wherein the drying process section carries out the drying process by an infiltration process for infiltrating the printing paper with solvent contained in the substrate treatment agent and a volatilization process for volatilizing the solvent into the atmosphere.

17. The offset printing press as claimed in claimed 14, wherein the printing paper is low-whiteness printing paper, and
the offset printing press is formed as a newspaper rotary press.

18. The offset printing press as claimed in claimed 14, wherein the substrate treatment agent is whiteness improvement agent.

19. (canceled)

20. (canceled)

21. The offset printing press as claimed in claim 14, wherein the substrate treatment agent is aqueous agent.

22. (canceled)

23. The offset printing press as claimed in claim 14, wherein the drying processing section includes a heating apparatus adapted to heat and dry the substrate treatment agent.

24. The offset printing press as claimed in claim 14, wherein the printing paper is low-whiteness printing paper and the offset printing press is configured as a rotary press, and
the substrate treatment agent supplying apparatus is disposed, within a range from a paper supplying section to a blanket drum nip section for a first color of the printing apparatus, on the downstream side with respect to an apparatus for varying a web path length to the first color blanket drum nip section and on the upstream side with respect to the first color blanket drum nip section.

25. (canceled)

26. (canceled)

27. (canceled)
